(19) United States
(12) Patent Application Publication
(10) Pub. No.: US 2005/0035764 A1
(43) Pub. Date: Feb. 17, 2005

(54) METHOD AND APPARATUS FOR DIRECTLY COOLING HOLLOW CONDUCTOR WOUND TRANSVERSE GRADIENT COIL BOARDS

(76) Inventors: Anthony Mantone, Florence, SC (US); Neil Clarke, Florence, SC (US); Tomas Duby, Florence, SC (US); Qin Liu, Waukesha, WI (US); Michael B. Sellers, Florence, SC (US)

Correspondence Address: JOSEPH S. HEINO, ESQ., 111 E. KILBOURN AVENUE, SUITE 1400, MILWAUKEE, WI, 53202, US

(21) Appl. No.: 10/604,748

(22) Filed: Aug. 14, 2003

(51) Int. Cl. G01V 3/00

(52) U.S. Cl. 324/318; 324/315; 324/309

(57) ABSTRACT

MRI operates by passing current through gradient coils to create a magnetic field. Creation of the magnetic field requires a relatively high current which causes a large heat build up within the MRI, especially in the patient space. The present invention provides for a hollow conductor through which a coolant can be passed directly during the application of current.

### BACKGROUND OF INVENTION

The present invention relates generally to magnetic resonance imaging (MRI) systems, and more particularly, to an assembly and method to dissipate the heat generated by transverse gradient coil boards that are used in an MRI.

When a substance such as human tissue is subjected to a uniform magnetic field (polarizing field B₀), the individual magnetic moments of the spins in the tissue attempt to align with the polarizing field, but precess about it in random order at their characteristic Larmor frequency. If the substance, or tissue, is subjected to a magnetic field (excitation field B₁) which is in the x-y plane and which is near the Larmor frequency, the net aligned moment, or “longitudinal magnetization”, M_{z} may be rotated, or “tipped”, into the x-y plane to produce a net transverse magnetic movement Mₜ. A signal is emitted by the excited spins after the excitation signal B₁ is terminated and this signal may be received and processed to form an image.

During patient scans, the gradient coils that produce the magnet field dissipate large amounts of heat, typically in the order of tens of kilowatts. The majority of this heat is generated by resistive heating of the copper electrical conductors that form x, y, and z axis gradient coils when these coils are energized. The amount of heat generated is in direct proportion to the electrical power supplied to the gradient coils. The large power dissipation not only results in an increase in temperature to the gradient coil, the heat produced is distributed within the gradient coil assembly or resonance modules and influences the temperature in two other critical regions. These two regions are located at boundaries of the gradient assembly and include the patient bore surface and warm bore surface adjacent to the cryostat that houses the magnets. Each of these three regions has a specific maximum temperature limitation. In the resonance module, there are material temperature limitations such as the glass transition temperature. That is, although the copper and fiber reinforced backing of the coils can tolerate temperatures in excess of 120° C., the epoxy to bond the layers to the typically has a much lower maximum working temperature of approximately from 70° to 100° C. Regulatory limits mandate a peak temperature on the patient or surface of 41° C. The warm bore surface also has a maximum temperature that is limited to approximately 40° C. to prevent excessive heat transfer through the warm bore surface into the cryostat. Further, temperature variations of more than 20° C. can cause field homogeneity variations due to temperature dependence of the field shim material that exhibits a magnetic property variation with temperature.

High current levels employed in conventional gradient coils produce significant heat proximate to the coil. This heat must be carried away from the coil and the magnet bore region to prevent damage to the coil and related structure, to avoid unwanted changes in the magnetic field due heating of magnet components, and to prevent unacceptable heating of a patient or other subject in the bore.

Cooling systems for gradient coils generally rely on conduction of the heat generated in the active circuits of the coil to water carrying pipes at some distance from the gradient coil, possibly as much as 10 mm away. The space between the active circuits and the water pipes is usually of material with good insulation properties, such as fiberglass, making heat conduction inefficient. The water carrying pipes are also radially outward of the coil heat regions resulting in the hottest regions being nearest to the patient being scanned with no cooling directly between the hot regions and the patient. The resulting heat generation puts thermal limits on the operation of the coil. In general, the market drivers are increased peak strengths and high throughput. These demands are driving up operating currents and voltages. The increases in operating currents are generating additional heat loads surpassing the ability of existing thermal systems.

### SUMMARY OF INVENTION

Transverse gradient boards are generally constructed by removing a predetermined path of copper from a rectangular base sheet. The copper sheet becomes a two dimensional spiral coil that is bent in an arc and assembled in a gradient coil to form X and Y axis dynamic field. It is, therefore, an object of the present invention to provide a two dimensional coil winding from accurately positioned hollow copper conductors forming a transverse electrical coil. It is a further object to provide such an apparatus that, in addition to providing the electrical and magnetic properties of the MRI, acts as a cooling circuit. It is also an object of the present invention to pass coolant directly through the conductor thus cooling the copper during the application of current.

Another object of the present invention is to improve the thermal efficiency of the MRI. It is a further object of the invention to provide a device having better image quality and the ability to scan images more quickly. It is yet a further object of the present invention to provide for a transverse gradient coil that permits passage of larger currents and voltages. It is yet a further object of the present invention to provide a device that enables new scanning protocols such as fMRI and coronary artery imaging. The improved thermal efficiency also improves product reliability by avoiding thermally induced failures. It is also an object of the present invention to provide a cooling system for use with “flat” gradient coils, such as may be used in an open architecture MRI.

The present invention has obtained these objects. It increases the thermal efficiency of MRI, improves imaging quality by reducing homogeneity variations due to temperature fluctuations and improves product reliability by reducing thermally related failures. The present invention also permits that passage of larger currents, thereby increasing magnetic field strength and image quality.

The present invention provides a self-shielded gradient coil assembly comprising a cylindrical inner coil winding having an inner surface and an outer surface. The inner coil winding is wound in a spiral. The winding further includes a continuous tubular hollow area through the winding, said tubular area permitting the continuous flow of coolant through it. A cooling system for circulating a coolant through the hollow area in the inner gradient coil is also provided as is a cylindrical outer coil winding having an inner surface and an outer surface, said outer coil winding being wound in a continuous spiral and defining a hollow annular space between the outer surface of the inner gradient coil and inner surface of the outer gradient coil, and a filler material is interposed between the inner and outer coil windings.

The present invention provides for using water, ethylene glycol, or a mixture of the two coolants. The present invention further provides that a plurality of the inner gradient coil windings have continuous tubular hollow areas for cooling the gradient coil. The present invention also provides for a self-shielded gradient coil assembly having a plurality of temperature sensors are located within the self-shielded gradient coil assembly, a coolant pump, a computer electronically linked to said coolant pump and said temperature sensors.

### BRIEF DESCRIPTION OF DRAWINGS

FIG. 1 is a sectional view, taken in a plane through the central longitudinal axis, of an MR gradient coil assembly of the prior art.

FIG. 2 is a simplified cross-sectional view of FIG. 1 of an MR gradient coil assembly of the prior art.

FIG. 3 is a sectional view, taken in a plane through the central longitudinal axis, of the MR gradient coil assembly of the present invention.

FIG. 4 is a schematic drawing of the cooling system for use with an MRI imaging system.

### DETAILED DESCRIPTION

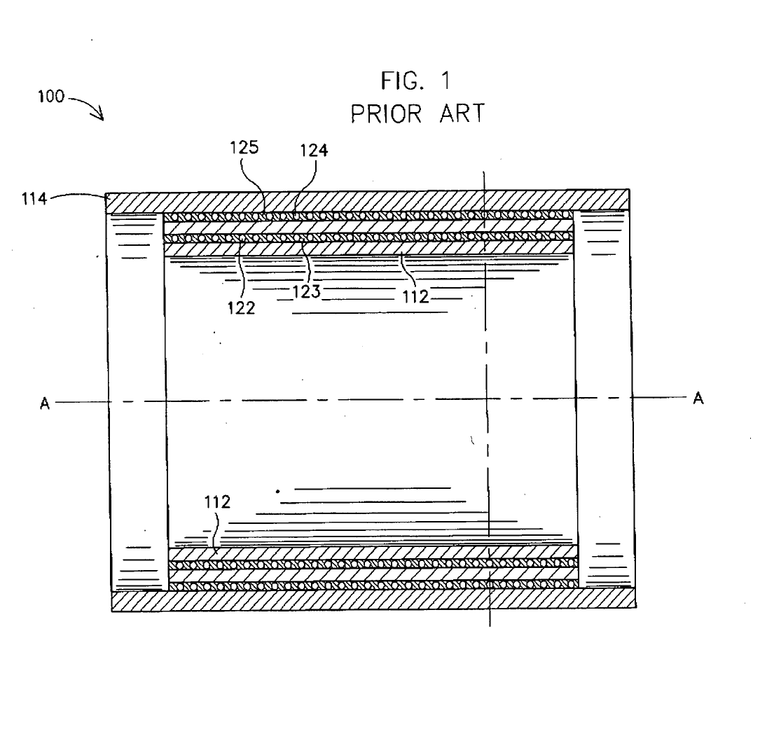

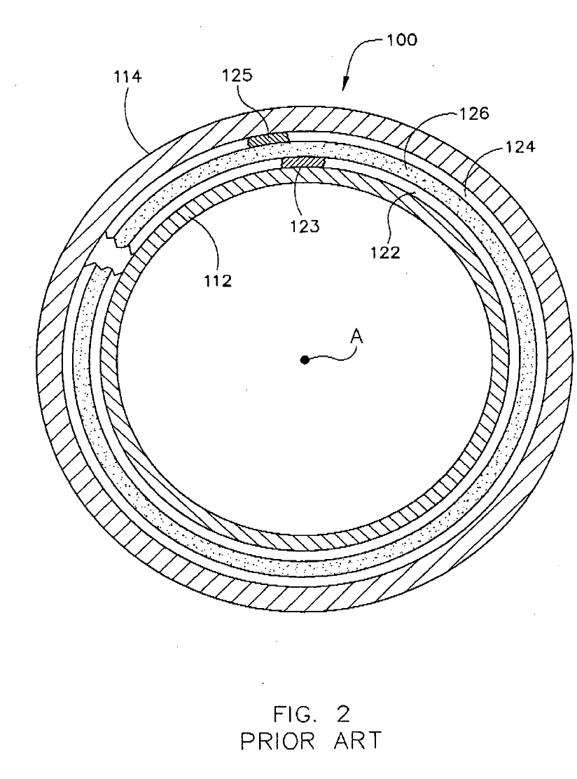

FIGS. 1 and 2 show a self-shielded gradient coil assembly 100 for an MR imaging system (not shown), comprising cylindrical inner and outer gradient coil windings 112 and 114, respectively, disposed in concentric arrangement with respect to common access A. A continuous cooling tube 122 is wound in a helix of the outer diameter surface of inner gradient coil winding 112 and a corresponding continuous cooling tube 124 is formed in a helix in the inner diameter surface of outer gradient coil winding 114, tubes 122 and 124 being respectively held in place by layers of epoxy 123 and 125. Inner gradient coil winding 112 includes inner coils of x-, y-, and z-gradient coils pairs, or sets, and outer gradient coil winding 114 includes the respective outer coils of the x-, y-, and z-gradient coil pairs or sets. Inner and outer gradient coil windings 112 and 114 are held in radially spaced apart coaxial relationship, relative to each other by annular end rings (not shown) which may be fixed to inner gradient coil winding 112 by screws. Epoxy filler used for layers 123 and 125 contains an alumina particulate material to increase its thermal conductivity. This enhances the effectiveness of the epoxy conducting heat, generated by the gradient coils away from the inner and outer gradient coil windings 112 and 114 and to cooling tubes 122 and 124. Preferably, cooling tubes 122 and 124 are fixed by respective epoxy layers 123 and 125 to the opposing surfaces of inner and outer gradient coil windings 112 and 114 as individual, separated units, and the epoxy material is allowed to cure.

FIG. 2 is a cross-sectional view of an MR gradient coil 100 assembly of the prior art showing the concentric relationship of the inner and outer gradient coils, 112 and 114. Also shown in FIG. 2 are the inner and outer cooling tubes 122 and 124. The cooling tubes, 122 and 124, are held into a concentric relationship using an epoxy filler, 123 and 125. A fiberglass cylinder is used to form the remaining cylindrical space and forms a layer 126 between the epoxy layers, 123 and 125.

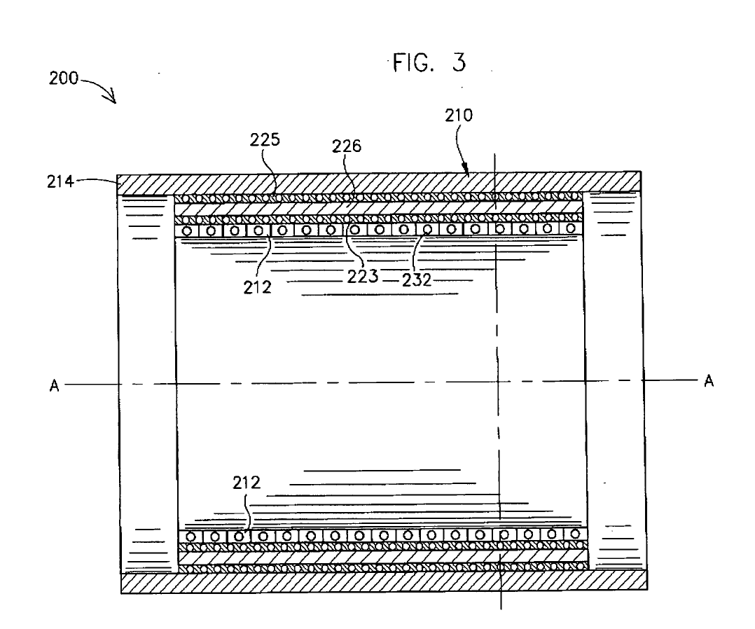

FIG. 3 shows a gradient coil assembly 200 for the current invention. The present invention provides for an inner and outer gradient coil 212, 214 in a concentric arrangement and having a common axis A. Working from the outward in, the self shielded gradient coil assembly 200 includes the outer gradient coil 214. Inward from the outer gradient coil 214 is a layer of epoxy 225. The layers 223, 225 of epoxy have extremely high strength to resist forces generated when electric currents are conducted by gradient coils 212, 214.

Inwardly from the epoxy layer 225 is a fiberglass cylinder 226. The fiberglass cylinder 226 is located between the layers of epoxy 223, 225. Inwardly from the fiberglass cylinder 226 are several layers of conductors which form the inner gradient coil 212.

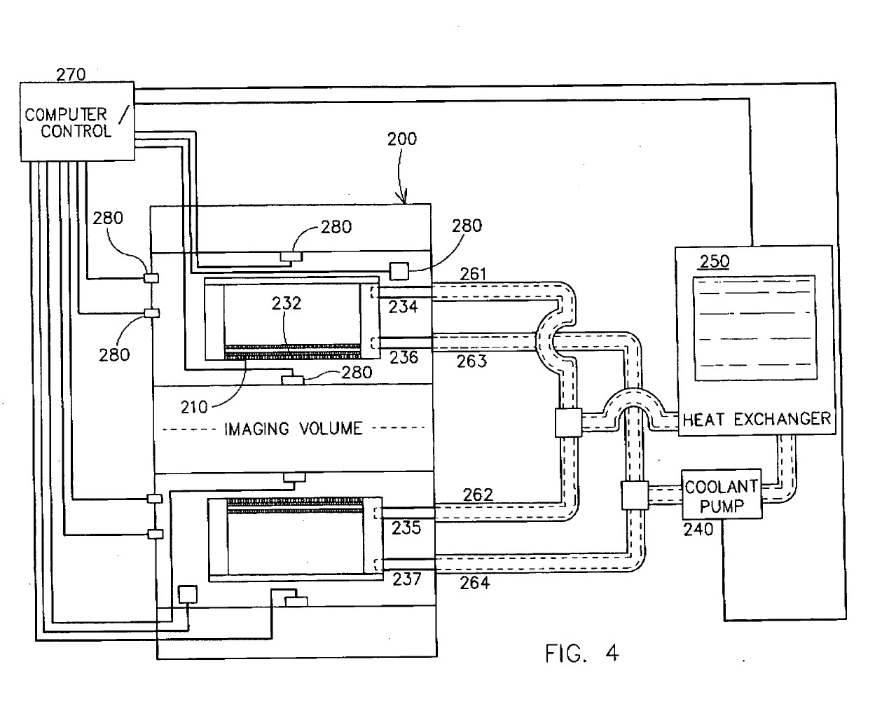

FIG. 3 shows the preferred embodiment of the present invention. Specifically, FIG. 3 shows an inner gradient coil 212 generally comprised of strips of a copper conductor. In the preferred embodiment, these conductive strips 212 are approximately 0.5 m×1 m×3.2 mm, although many sizes and shapes of conductors 212 could be used and the above is not a limitation of the invention. The innermost gradient coil 212 features a hollow area 232 within the actual conductor for passage of coolant. This coolant tube 232 is in fact connected to a cooling system depicted in FIG. 4 to dissipate the heat generated by the gradient coils. This gradient coil 212 is also referred to as a hollow conductor 212.

Obviously, the coolant must travel through the entire gradient coil 212. Unfortunately, with coolant entering only one end of the gradient coil and emerging from the other, effective cooling is not accomplished. It is therefore desirable that several parallel cooling circuits made of hollow conductive material be used. That is, coolant will enter the gradient coil 212 at several points and leave at several points.

The drawings in combination with the disclosure are not intended to limit use of the present invention to regular MRI imaging machines. Although not pictured, the hollow wound conductors of the present invention could wound into the flat type of conductors normally associated with open-architecture MRI imaging systems.

FIG. 4 is a schematic of the cooling system provided to reduce the heat generated by the gradient coils of the MRI system. Dissipating heat within the MRI is important to avoid overheating of the gradient coils as well as making patients uncomfortable during testing. The gradient coils are excited by a corresponding gradient amplifier to produce magnetic field gradients used for spatially encoding signals acquired by the RF coils used to reconstruct an image in a known manner.

The gradient coils, when generating a magnetic field, generate several kilowatts of heat due to the resistance of the copper coils. This heat must be dissipated for proper operation of the MRI machine. As discussed above, a coolant, such as water, air, ethylene glycol, propylene glycol, or mixtures of any of the above, is circulated through the gradient coils. Anti-corrosive additives to the coolant may also be used. The type of coolant employed is not intended to be a limitation of the invention. Nearly any coolant could be used to accomplish the same purpose. The coolant then carries the heat away from the gradient coil 200.

Now, referring specifically to FIG. 4, coolant enters the resonance module or chamber via inlet ports 234, 235. Coolant is fed to the resonance module by a coolant pump 240 which is fluidly connected to inlet ports 234, 235 via the external fluid lines 261, 262. To assist in maintaining the desired coolant temperature, coolant lines 261, 262 are sufficiently insulated to eliminate any variance in coolant temperature as it enters the self-shielded gradient coil 200. Although two inlet and outlet ports for coolant are shown in FIG. 4, in other embodiments there may be just one inlet and one outlet, since the cooling tubes 232 are circular around the imaging volume, or there may be more than two to provide greater capacity to remove the heat load caused by extended MRI studies.

Coolant pump 240 circulates coolant at a temperature dependent on system needs and, in accordance with the present invention. Coolant entering the self-shielded gradient coil 210 travels through cooling tubes 232 and while doing so absorbs heat from the coils. The coolant carrying the heat load is then drained away from the gradient coils and exits via the outlet ports 236, 237, which transport the heated coolant to a chiller/heat exchanger 250 via return lines 263, 264. The heat exchanger 250 is designed to dissipate heat absorbed from the coolant and lower the coolant temperature to a desired temperature.

A computer control 270 could be used to monitor temperature sensors 280. If the temperature sensors 280 read a temperature that is above the desired level, the computer 270 sends a signal to the pump 240 to increase coolant flow or shut the MRI machine down. If the temperature falls below a specified value the computer 270 can decrease or halt the coolant flow if the MRI is not operating.

Accordingly, an improved device for cooling the gradient coils in an MRI magnet has been disclosed. The cooling system of the present invention provides for a gradient coil wound of a hollow conductor such that fluid can flow through the conductor, cooling the conductor. In one aspect of the invention, the hollow conductor could be used in an open architecture MRI in a flat gradient coil configuration. In another aspect of the invention, several lengths of hollow conductor, each being connected to a coolant supply could comprise the gradient coil. The hollow conductor of the present invention can be used for shielded an unshielded gradient coils in addition to gradient coils and transverse gradient coils.

Although we have very specifically described the preferred embodiments of the invention herein, it is to be understood that changes can be made to the improvements disclosed without departing from the scope of the invention. Therefore, it is to be understood that the scope of the invention is not to be overly limited by the specification and the drawings, but is to be determined by the broadest possible interpretation of the claims.

1. A transverse gradient coil comprising:
a strip of electrically conductive material; and
said strip of electrically conductive material having a hollow portion such that fluid is permitted to flow through the conductive material.

2. The transverse gradient coil assembly of claim 1 wherein the hollow conductor is wound in a helix to form the general shape of a cylinder.

3. The transverse gradient coil assembly of claim 2 wherein the hollow conductor is wound for use in a shielded gradient coil.

4. The transverse gradient coil assembly of claim 3 wherein the gradient coil is comprised of a plurality of hollow conductor sections, each permitting fluid to flow through the conductor.

5. The transverse gradient coil assembly of claim 4 wherein the hollow conductor is wound for use in a flat gradient coil, for use in an open architecture Magnetic Resonance Imaging device.

6. The transverse gradient coil assembly of claim 5 wherein additional cooling is provided by a plurality of coolant pipes situated in thermal contact around the gradient coil.

7. The transverse gradient coil assembly of claim 6 wherein the coolant passed through the tubular area is water, ethylene glycol or a mixture of the two coolants.

8. An MRI apparatus comprising:
a magnetic resonance imaging system (MRI) having a plurality of gradient coils positioned about a bore of a magnet to impress a polarizing magnetic field and an RF transceiver system and an RF switch controlled by a pulse mode to transmit RF signals to an RF coil assembly to acquire MR images;
an input device to select a scan sequence; and
wherein a gradient coil is wound of a hollow conductor elements such that fluid is permitted to flow through the conductor.

9. The MRI apparatus of claim 8 wherein the hollow conductor is wound to comprise a transverse gradient coil.

10. The MRI apparatus of claim 9 wherein the hollow conductor is wound for use in a shielded gradient coil assembly.

11. The MRI apparatus of claim 10 wherein the gradient coil is comprised of a plurality of hollow conductor sections, each permitting fluid to flow through the conductor.

12. The MRI apparatus of claim 11 wherein the hollow conductor is wound for use in a flat gradient coil, for use in an open architecture Magnetic Resonance Imaging device.

13. The MRI apparatus of claim 12 wherein additional cooling is provided by a plurality of coolant pipes situated in thermal contact around the gradient coil.

14. The MRI apparatus of claim 13 wherein the coolant passed through the tubular area is water, ethylene glycol, or a mixture of the two coolants.

15. A gradient coil assembly comprising:
a strip of conductive material;
said strip of conductive material being formed into a cylindrical coil winding;
said winding including a continuous tubular hollow area through the winding, said hollow area permitting the continuous flow of coolant.

16. The gradient coil assembly of claim 15 wherein the gradient coil is used for a shielded gradient coil assembly.

17. The gradient coil assembly of claim 16 wherein the gradient coil is comprised of a plurality of hollow conductor sections, each permitting fluid to flow through the conductor.

18. The gradient coil assembly of claim 17 wherein additional cooling is provided by a plurality of coolant pipes situated in thermal contact around the hollow gradient coil.

19. The gradient coil assembly of claim 18 wherein the coolant passed through the tubular area is water, ethylene glycol, or a mixture of the two coolants.

20. A transverse gradient coil assembly comprising:
a cylindrical inner coil winding, said winding further including a continuous tubular hollow area through the winding, said tubular area permitting the continuous flow of coolant;
a filler material surrounding the coil winding; and
a plurality of coolant pipes situated in thermal contact with the gradient coil in the filler material.

21. The transverse gradient coil assembly of claim 18 wherein the gradient coil is comprised of a plurality of hollow conductor sections, each permitting fluid to flow through the hollow conductor.

22. A method for cooling a gradient coil assembly comprising the steps of:
providing a conductor having a continuous hollow center;
winding the conductor into a spiral such that said conductor forms a cylinder;
providing a cooling system for circulating a coolant through the hollow area in the inner gradient coil.

23. The method of claim 22 further comprising the step of locating the wound cylindrical conductor in coaxial relationship with other cylindrical windings.

24. The method of claim 23 further comprising the step of positioning said gradient coil windings in a radially spaced-apart coaxial relationship.

25. The method of claim 24 further comprising the step of circulating coolant through said gradient coil windings.
